(19) United States
(12) Patent Application Publication
(10) Pub. No.: US 2009/0123692 A1
(43) Pub. Date: May 14, 2009

(54) SELF-ALIGNING MODULAR, RAISED PANELS AND AN ASSEMBLY SYSTEM THEREOF

(75) Inventor: Donald L. Kaump, Seattle, WA (US)

Correspondence Address: SEED INTELLECTUAL PROPERTY LAW GROUP PLLC, 701 FIFTH AVE, SUITE 5400, SEATTLE, WA, 98104, US

(73) Assignee: MODULAR ARTS, INC., Seattle, WA (US)

(21) Appl. No.: 11/940,130

(22) Filed: Nov. 14, 2007

(51) Int. Cl. B32B 3/06

(52) U.S. Cl. 428/99

(57) ABSTRACT

A modular panel and system of panels provides an aesthetically pleasing covering for an interior surface of a building. The panels include a skin, which in some embodiments includes a backing. The panels have a three-dimensional relief and can be abutted together to form a system of panels forming an integral three-dimensional pattern, a perimeter of the panels having a plurality of interlocking mechanisms positioned such that when the interlocking mechanism of the panel engages the interlocking mechanism of at least one adjacent panel, the three-dimensional pattern seamlessly continues in all three dimensions, from the panel into the at least one adjacent panel.

### BACKGROUND

1. Field

The present disclosure generally relates to panels, and more particularly, to panels for covering an interior surface and forming an integral three-dimensional pattern, and a system for assembling the same.

2. Description of the Related Art

Coverings for interior surfaces in both residential and commercial buildings are well known in the art. Coverings include wallboard, ceiling tiles, or wainscoting, for example. Interior surfaces such as walls and ceilings are typically covered with gypsum-based plaster panels sandwiched between two sheets of board cover paper, sometimes referred to as “drywall” or “plaster-board” (gypsum is also known as “calcined stucco”; whereas the chemical name for gypsum is calcium sulfate hemihydrate). Wallboard typically has a flat, smooth, papered-covered surface and slightly beveled edges. The beveled edges are abutted together during installation and the seams between the wallboard panels are typically filled with a standard joint compound and taped with drywall tape. The seams between adjacent sheets of wallboard disappear after the process of taping, mudding, and finishing. Drywall is usually fastened to the studs or joists of the walls or ceiling, respectively, with drywall screws. Traditionally, wallboard has been designed to not only be flat, but also to facilitate a smooth installation and finish.

Molded structures exist that allow individuals to install arches, posts and capitols and other architectural features, and to caulk or otherwise join such features to the surrounding wall and/or ceiling to add distinction to the room. These architectural features are then painted along with the walls and ceiling, giving the room a more complex and interesting appearance.

One example of a decorative covering for an interior surface is wainscoting. Wainscoting is typically installed over the top of wallboard on interior walls for decorative purposes. The material used for the wainscoting is most often wood, but can also be wood fiber particleboard, or straw particleboard. Straw particleboard uses waste wheat straw as the raw material.

Another gypsum-based material, such as glass-fiber reinforced gypsum, has been used to make shell castings for decorating ceilings, columns, and other interior objects. One type of decorative covering is a panel created by weaving strips of wood veneer. Another type of decorative covering is a wood panel that has a sculptural design carved or laser cut into the wood panel. In comparison to drywall, these panels are much more expensive because they must be custom ordered, machined or hand carved, and they are made out of wood.

In addition, when assembling a plurality of panels, aligning the panels to introduce a seamless transition from one panel to another is typically an arduous task.

### BRIEF SUMMARY

According to one embodiment, a composite panel is provided for use with at least one adjacent composite panel, in covering an interior surface of a structure, the composite panel including a hardened structural skin fabricated from a first material comprising a gypsum based material, a first surface of the structural skin defining an outer surface of the panel having a three-dimensional relief, a magnitude of the relief varying over an area of the outer surface for defining a three-dimensional pattern, and a second surface defining an inner surface of the hardened structural skin, a distance between the first and second surfaces defining a thickness of the hardened structural skin. The composite panel further includes a backing member fabricated from a second material, different from the first material, the backing member having a first surface and a second surface, opposing the first surface, the first surface being bonded to the second surface of the hardened structural skin, the second surface of the backing member having a substantially flat portion to form an inner surface of the panel for being positioned against the interior surface of the structure, the second material having a lower density than a density of the first material. Further more, a perimeter of the composite panel includes a plurality of projections and recesses positioned such that when the projections of the composite panel engages the recesses of the at least one adjacent composite panel, a height of the three-dimensional pattern aligns and the pattern seamlessly continues, from the composite panel into the at least one adjacent composite panel.

According to one aspect, the projection of the composite panel includes an at least partially arcuate tab and the recess of the at least one adjacent panel includes an at least partially arcuate crevice, the crevice being shaped to complementary receive the arcuate tab, the arcuate tab and the crevice being formed such that when the arcuate tab extends into the crevice and the periphery of the composite panel positions contiguous the periphery of the adjacent composite panel, the three-dimensional pattern seamlessly continues in all three dimensions, from the composite panel into the at least one adjacent composite panel, thereby providing a user an aligning mechanism and substantially preventing user error in aligning the composite panel with the at least one adjacent composite panel.

According to another embodiment, a system for aesthetically covering at least a portion of at least one wall is provided, the system including a plurality of panels each having a first surface and a second surface, opposing the first surface, a distance between the first and second surfaces defining a depth of the panel, the depth varying across at least a portion of the panel for defining a sculptural relief and forming a three-dimensional pattern on the first surface, the second surface being configured to conform to a surface of the at least one wall and be affixed to the at least one wall for displaying the three-dimensional pattern, the sculptural relief of each panel being formed such that when the panels are assembled to form the system, the three-dimensional pattern seamlessly flows into adjacent panels in all three dimensions, providing an appearance of a unitary panel having a seamless integral three-dimensional pattern formed by the individual three-dimensional patterns of each panel. The system further includes a plurality of interlocking mechanisms formed along a perimeter of each panel, the interlocking mechanisms of one panel being configured to engage the interlocking mechanisms of adjacent panels, respectively, the individual three-dimensional patterns aligning along all three dimensions when the interlocking mechanisms are engaged.

According to one aspect, the interlocking mechanism comprises a key formed on a perimeter of at least one panel and a slot formed on a perimeter of panels positionable adjacent the at least one panel, the key having a first flange extending in a first direction and a second flange extending in a second direction, different from the first direction, the slot having a first recess adjacent an outermost edge of the periphery and a second recess open to the first recess and spaced from the outermost edge, the first recess being sized to receive the first and second flanges of the key, and the second recess being sized to securely receive the second flange of the key and prevent lateral movement thereof toward the outermost periphery.

### BRIEF DESCRIPTION OF THE DRAWINGS

FIG. 1 is an isometric view of a room where one of the interior surfaces in the room is covered with panels according to one embodiment.

FIG. 2A-2D are front plan views of distinct three-dimensional relief patterns, according to other respective embodiments.

FIG. 3 is an isometric view of a panel having a three-dimensional relief pattern according to another embodiment.

FIG. 4 is a front plan view of the panel of FIG. 3.

FIG. 5 is a cross-sectional view of the panel of FIG. 4, viewed across section 5-5.

FIG. 6 is a front plan view of another panel having a three-dimensional relief pattern and having reinforced edges according to yet another embodiment.

FIG. 7 is a cross-sectional view of the panel of FIG. 6, viewed across section 7-7.

FIG. 8 is a front plan view of a panel having a three-dimensional relief pattern according to still another embodiment.

FIG. 9 is a cross-sectional view of the panel of FIG. 8, viewed across section 9-9 of FIG. 8.

FIG. 10A is an isometric view of a system of self-aligning panels having a three-dimensional relief pattern according to another embodiment in a pre-assembled state.

FIG. 10B is an isometric view of the system of self-aligning panels of FIG. 10A in an assembled state.

FIG. 11A is an isometric view of a system of self-aligning panels having a three-dimensional relief pattern according to yet another embodiment in a pre-assembled state.

FIG. 11B is an isometric view of the system of self-aligning panels of FIG. 11A in an assembled state.

FIG. 12 is a flow diagram of a method of manufacturing a panel according to one embodiment.

FIG. 13 is a flow diagram of a method of installing panels on an interior surface according to one embodiment.

### DETAILED DESCRIPTION OF THE INVENTION

In the following description, certain specific details are set forth in order to provide a thorough understanding of various embodiments of the invention. However, one skilled in the art will understand that the invention may be practiced without some of these details. In other instances, well-known structures, installation techniques and manufacturing techniques associated with interior surface coverings such as wallboard, ceiling panels, or wainscoting, etc., may not be shown or described in detail to avoid unnecessarily obscuring descriptions of the embodiments of the invention.

This description initially presents a general overview of a system of modular, composite panels attached to an interior surface of a building and then provides a structural description of an individual modular, composite panel according to one embodiment of the invention. Next, the manufacturing process of the individual panel is described. Finally, the system of panels and the installation thereof is revisited and described in more detail.

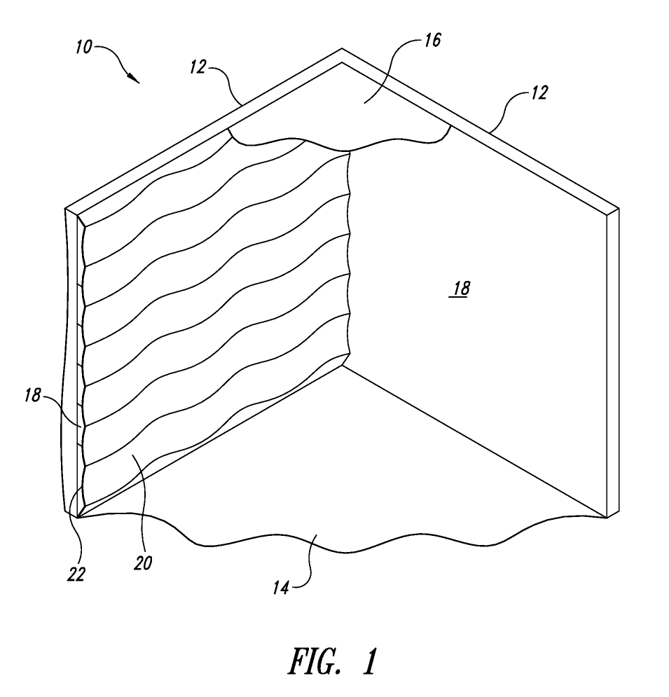

FIG. 1 illustrates a cut away view of a room 10 having interior surfaces 18 such as walls 12, a floor 14, and a ceiling 16 with one of the walls 12 covered by a system of panels 20 according to one embodiment of the invention. The surface underneath the system of panels 20 can be existing wallboard or some other substrate.

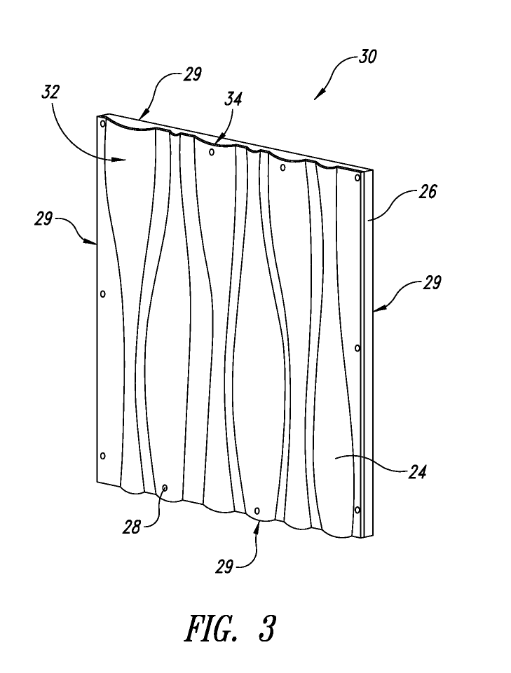

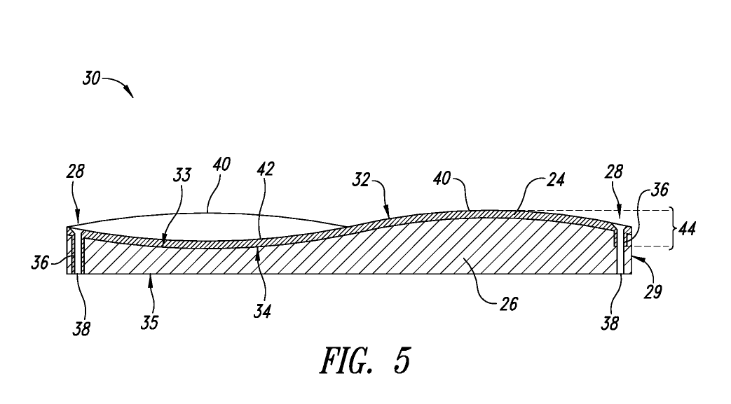

The system of panels 20 includes more than one panel 30 (FIG. 3), each having an outer surface that forms a three-dimensional relief 44 (FIG. 5), a magnitude of the relief varying over an area of the outer surface for defining a three-dimensional pattern. The system of panels 20 forms a continuous integral three-dimensional pattern when the individual panels 30 are assembled adjacent one another. When the panels 30 are assembled, the individual three-dimensional pattern of each panel 30 aligns with the three-dimensional pattern of adjacent panels 30 along all three dimensions to seamlessly form the integral three-dimensional pattern.

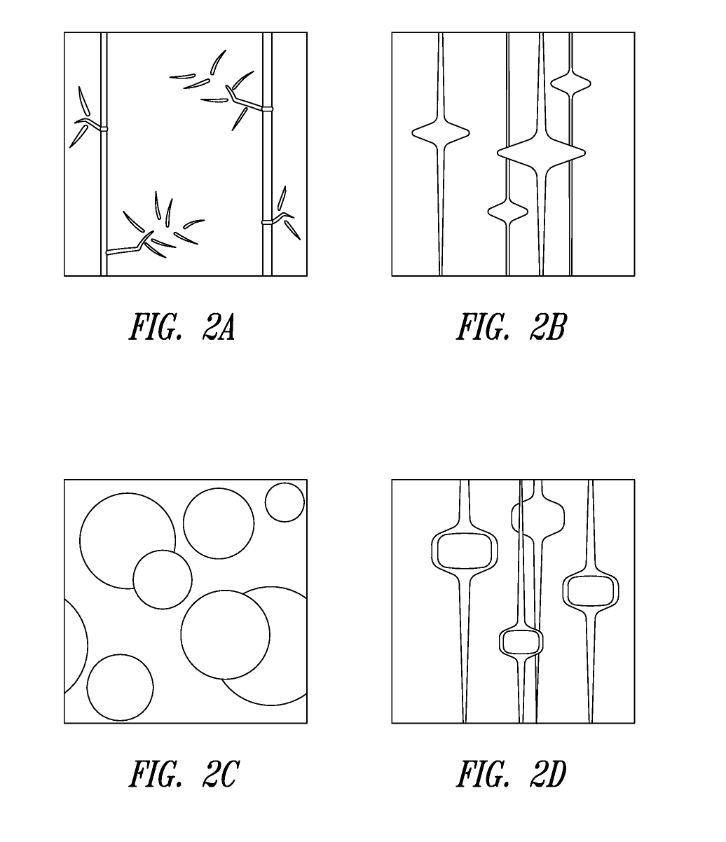

Accordingly, when the panels 30 are aligned from edge to edge, the integral three-dimensional pattern is seamlessly continual and/or flowing, presenting a viewer with the integral three-dimensional pattern. The integral three-dimensional pattern can flow multi-directionally, vertically, horizontally, diagonally, arcuately and/or some other direction across the panels 30. In addition, a design of the integral three-dimensional pattern is not limited to the illustrated embodiment in FIG. 1. FIGS. 2A through 2D illustrate a number of other possible patterns such as a “zen” pattern (FIG. 2A), a “lamps” pattern (FIG. 2B), a “big dots” pattern (FIG. 2C), and a “tvees” pattern (FIG. 2D).

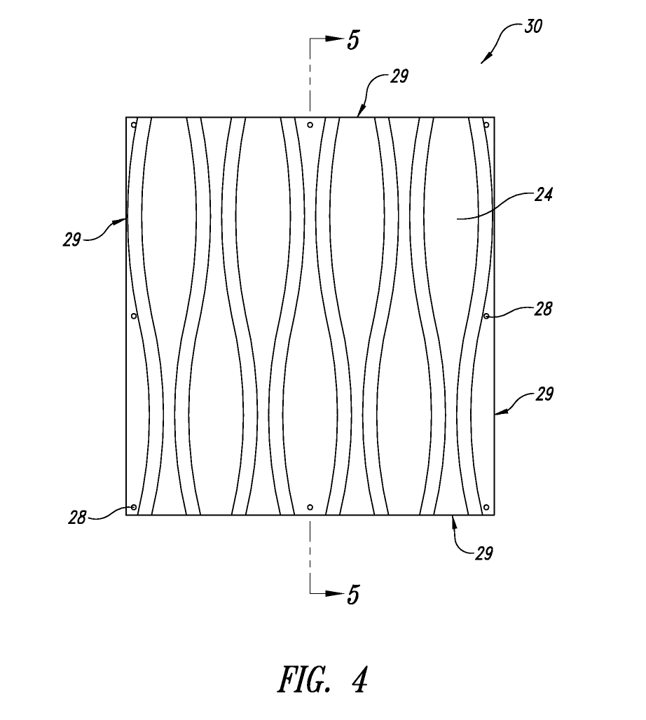

FIGS. 3 and 4 illustrate a composition of each of the panels 30. In one embodiment, each panel 30 may be fabricated from a unitary body of material or it can be a composite of more than one material. In one embodiment, each panel 30 includes a reinforced skin 24, a backing member 26, a number of mounting points 28, and a perimeter defined by terminal edges 29. The reinforced skin 24 can be made from a first material, such as a gypsum-based material. The first material may further include glass, cellulose, polyester, carbon, or any number of strength-improving fibers. The reinforced skin 24 has an outer surface 32 and an inner surface 34. The outer surface 32 is generally smooth while the inner surface 34 can have a rougher surface finish. The rougher surface finish of the inner surface 34 can enhance the attachment of the backing member 26 when the backing member 26 is molded with the reinforced skin 24.

In one embodiment, the backing member 26 can be made from a second material having a lower density than the first material. For example, the second material can include a lightweight aggregate, for example, a low density mineral aggregate. In addition, or instead, the second material may include lightweight filler.

In an alternative embodiment, the reinforced skin 24, the backing member 26, or both can be made from a cement-based material such as Portland cement.

As illustrated in FIG. 5, the backing member 26 has a first surface 33 and a second surface 35. The first surface 33 is molded with and in contact with the reinforced skin 24. The second surface 35 is configured to be substantially flat for mounting the panel 30 to a flat, interior surface.

In addition to the reinforced skin 24 and the backing member 26, the panel 30 can have mounting points 28 according to one embodiment of the invention. FIG. 5 illustrates a cross sectional view of a panel 30 with one partially reinforced mounting point 28 toward a first side of the panel 30 and a fully reinforced mounting point 28 toward a second side of the panel 30, opposing the first side. Both types of reinforced mounting points 28 are depicted in FIG. 5 for illustrative purposes. An individual panel 30 can be configured with only one type or both types of mounting points 28, or a larger or lesser quantity of mounting points 28. The reinforced mounting point 28 includes a grommet member 36 that is configured to reinforce an opening 38, which extends therethrough.

In one embodiment, the grommet member 36 can be integrally formed or cast with the reinforced skin 24 and extend from the inner surface 34 of the reinforced skin 24. The extended length of the grommet member 36 from the inner surface of the skin 24 can be varied. In one embodiment, the grommet member 36 extends partly through the opening 38 to only partially reinforce the panel 30. In another embodiment, the grommet member 36 extends substantially along an entire length of the opening 38. One of ordinary skill in the art will appreciate and understand that the grommet member 36 can be integrally cast with the skin 24. Additionally or alternatively, the grommet member 36 may be a separate structural member that could be inserted and/or bonded in the opening 38 after the skin 24 is cast or during the casting process.

The panel 30 includes the three-dimensional relief pattern 44 having at least one peak 40 and at least one valley 42. The peaks 40 and valleys 42 can be variable in a height or a depth thereof, relative to the second surface 35 of the backing member 26, from one location to a next over an area of the panel 30. A dimensional offset or relief between the peaks 40 and the valleys 42 is sufficient to produce the three-dimensional appearance of the pattern to an observer. For example, in one embodiment, a maximum relief dimension can be in a range of about 1.0 inch to 2.0 inches.

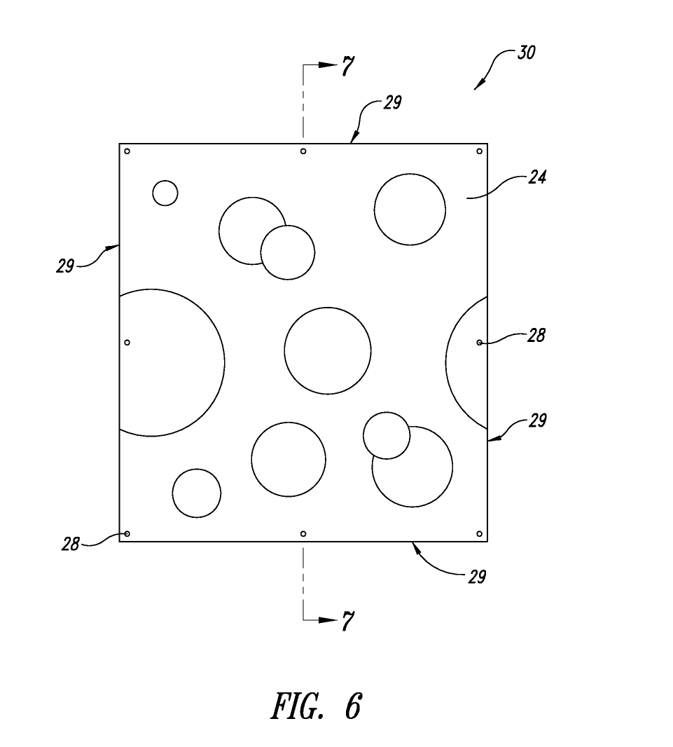

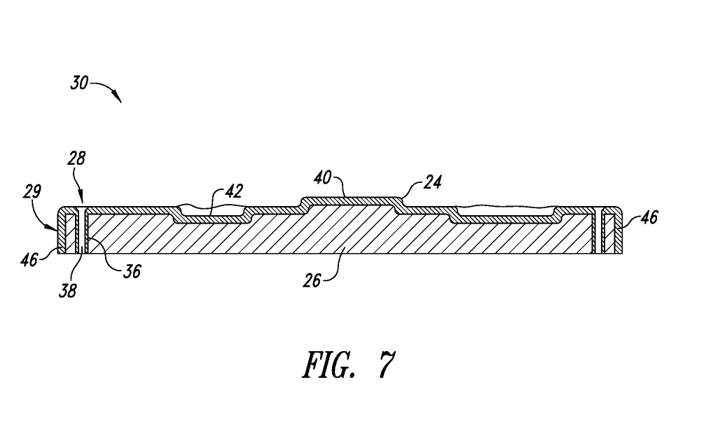

FIGS. 6 and 7 illustrate a panel 30 according to another embodiment. FIG. 6 depicts the panel 30 with a different three-dimensional relief pattern 44.

FIG. 7 is a cross sectional view of the panel of FIG. 6 having flanges 46 extending from the reinforced skin 24 where the flanges 46 form the terminal edges 29 of the panel 30. In the illustrated embodiment, the flanges 46 are integrally cast with the reinforced skin 24, same as the material of the reinforced skin 24. However, one of ordinary skill in the art will appreciate and understand that the flanges 46 may be bonded to or toward the terminal edges 29 of the panel 30 after the panel 30 is constructed. In an alternative embodiment, the perimeter of the panel 30 is interference fit into or bonded with a strip (not shown), for example a metal or a ceramic strip.

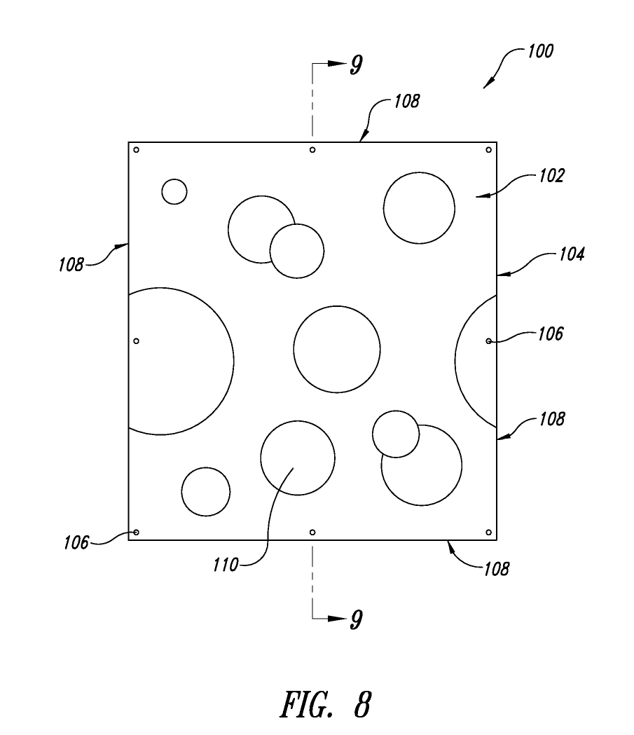

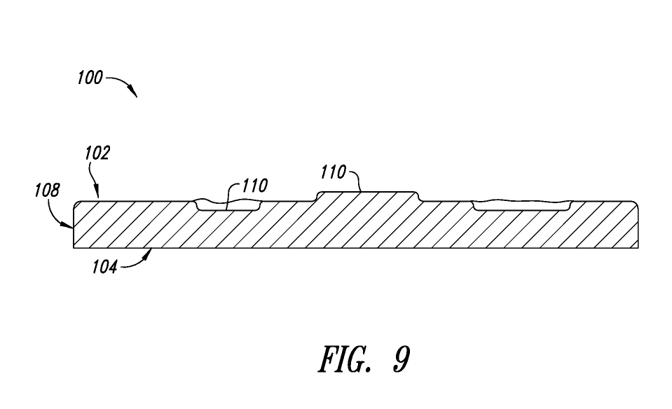

FIGS. 8 and 9 illustrates a one-piece panel 100 having a front surface 102, a back surface 104, a number of mounting points 106, and a perimeter defined by terminal edges 108. The panel 100 can be made from a gypsum-based material, a cement-based material, or some other type of casting material. If a gypsum-based material is used, it may further contain fibers for added strength. A cement-based material as Portland cement can also be used to form the panel 100. The front surface 102 in the illustrated embodiment has a three-dimensional relief pattern 110.

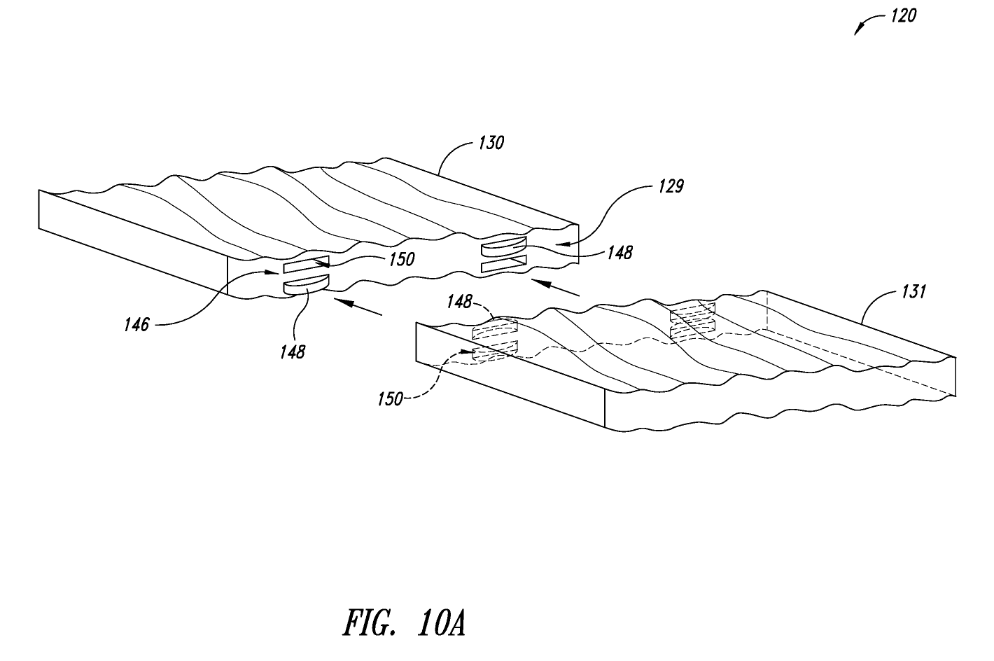

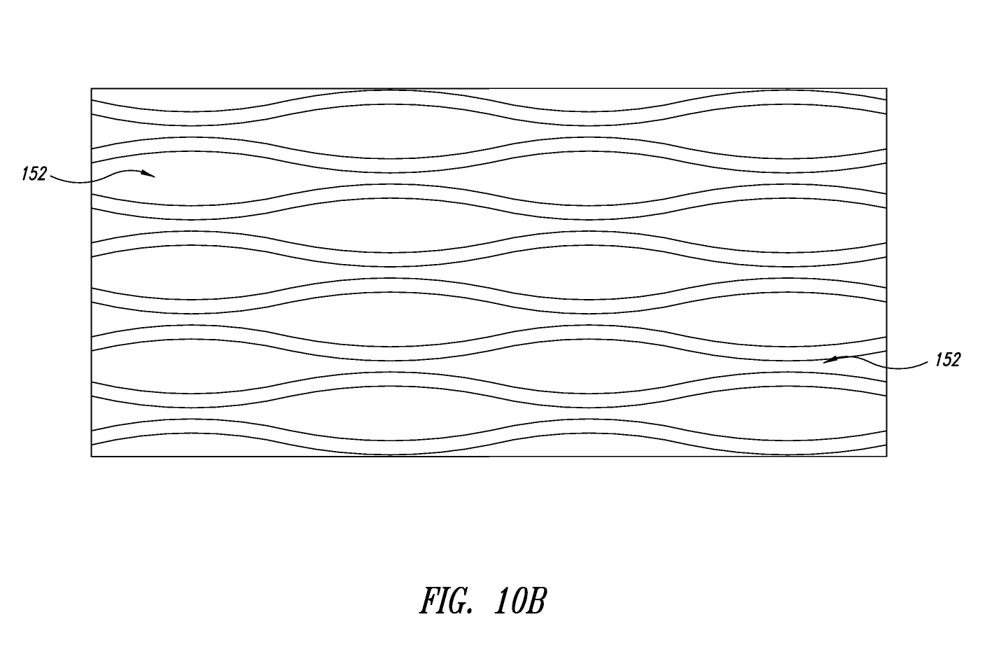

FIGS. 10A and 10B illustrate yet another embodiment, in which a self-aligning system of panels 120 for forming an integral three-dimensional pattern includes a first panel 130 and at least a second panel 131 that is positionable adjacent the first panel 130 when the panels are assembled. Each panel 130, 131 includes a three-dimensional pattern as discussed above and when assembled the outer surface of the panels, and the three-dimensional relief formed thereon, align to form the integral three-dimensional pattern.

The first and at least second panels 130, 131 each further includes a perimeter 129 having at least one, or a plurality of interlocking mechanisms 146 positioned such that when the interlocking mechanism 146 of the first panel 130 engages the interlocking mechanism 146 of the at least second panel 131, the three-dimensional pattern seamlessly continues in all three dimensions, from the first panel 130 into the at least second panel 131 for forming the integral three-dimensional pattern.

In one embodiment, each interlocking mechanism 146 of the first panel 130 includes at least one protrusion 148 and at least one recess 150. Similarly, each interlocking mechanism 146 of the at least second panel 131 includes at least one protrusion 148 and at least one recess 150 configured to receive and fixedly engage the recess 150 and protrusion 148 of the first panel 130, respectively. When the user aligns and engages the respective protrusions 148 and recesses 150 of the first and the at least second panels 130, 131, the three-dimensional relief of the first panel 130 automatically aligns in all three dimensions with the three-dimensional relief of the at least second panel 131 without the installer being required to shim or otherwise compensate for an uneven substrate. Accordingly, the system 120 is self-aligning, substantially eliminating the risk of misalignment of the respective three-dimensional patterns of each of the panels 130, 131. The protrusions 148 can be monolithic or integral to the panels 130, 131, or one or more of the protrusions 148 can be removable.

FIG. 10A illustrates the interlocking mechanisms 146 on only one perimeter segment 129 of each of the panels 130, 131, for clarity of description and illustration. In embodiments in which more panels are used, all the perimeter portions which position adjacent a perimeter portion of an adjacent panel can include the interlocking mechanism 146. Furthermore, although two sets of interlocking mechanisms 146 are illustrated, one of ordinary skill in the art will appreciate that one or more than two interlocking mechanisms 146 per each perimeter segment 129 may be utilized in other embodiments.

As illustrated in FIG. 10A, the first and second panels 130, 131 are biased toward each other until the respective protrusions 148 penetrate the recesses 150, respectively, until respective perimeters 129 of the first and second panels 130, 131 position contiguous one another.

FIG. 10B illustrates the system 120 of FIG. 10A in an assembled state, in which the three-dimensional pattern of the first panel 130 aligns with the three-dimensional pattern of the at least second panel 131 in all three-dimensions to produce the integral three-dimensional pattern 152 seamlessly, spanning across the at least two panels 130, 131. Accordingly, the observer will perceive the integral three-dimensional pattern 152 as one aesthetically pleasing pattern without being able to distinguish the first panel 130 from the at least second panel 131.

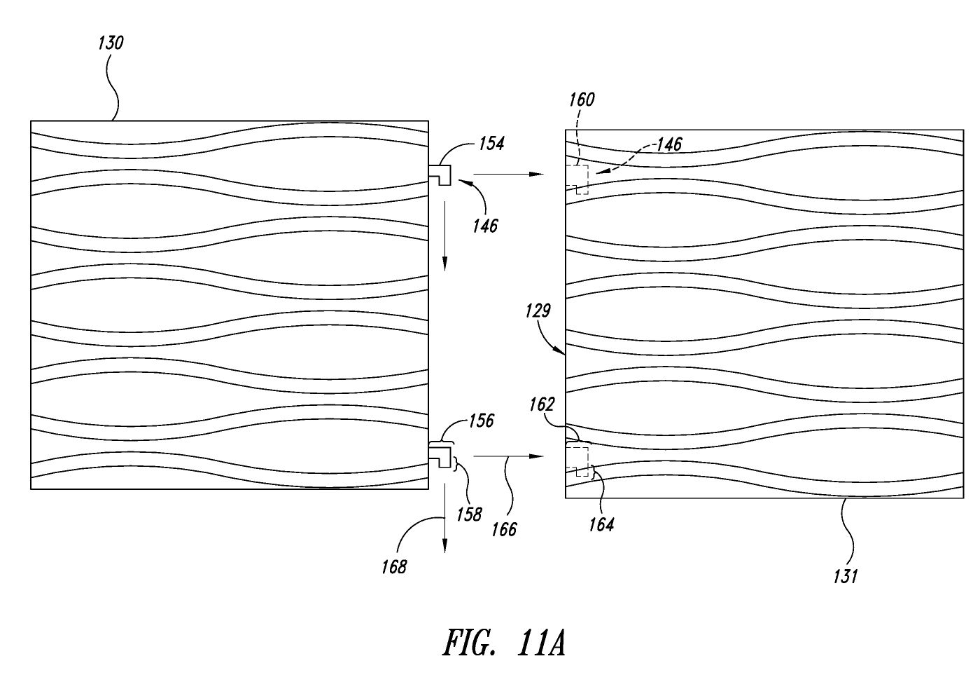

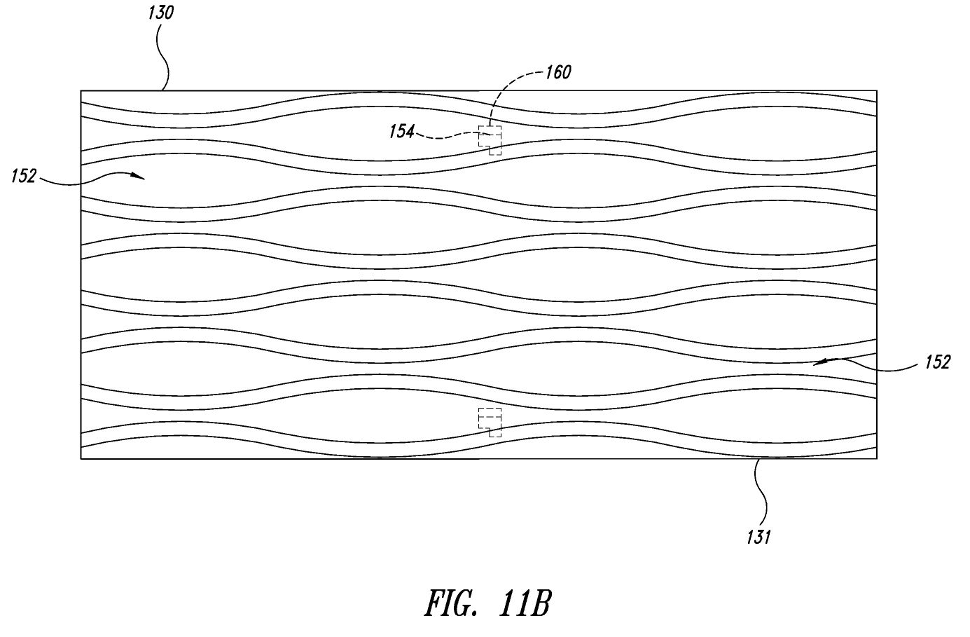

FIGS. 11A and 11B illustrate still another embodiment, in which the interlocking mechanism 146 of the first panel 130 includes a key 154 having a first flange 156 and a second flange 158, extending in a direction different from a direction along which the first flange 156 extends. Furthermore, the interlocking mechanism 146 of the at least second panel includes a slot 160 having a first recess 162 configured or sized to receive the key 154 and a second recess 164, extending in a direction different from a direction along which the first recess extends. The first recess 162 is contiguous and open to the perimeter 129 of the at least second panel 131, and extends away from the perimeter 129. The second recess 164 is open to the first recess 162 and is sized to securely receive the second flange 158 of the interlocking mechanism 146 of the first panel 130.

During assembly, the user biases the panels 130, 131 toward each other in a first direction 166 such that the first recess 162 receives the first and second flanges 156, 158. When the first flange 156 reaches a terminal end of the first recess 162, spaced away from the perimeter 129, the user biases the first panel in a second direction 168, to insert the second flange 158 in the second recess 164.

As illustrated in FIG. 11B, the first and second flanges 156, 158 and the first and second recesses 162, 164 are positioned on the respective panels 130, 131 such that when the second flange 158 engages the second recess 164, the individual three-dimensional relief of each of the panels 130, 131 automatically align to produce the integral three-dimensional pattern 152. In this position the second recess 164 prevents lateral displacement of the second flange 158, and thus of the panels 130, 131 with respect to each other.

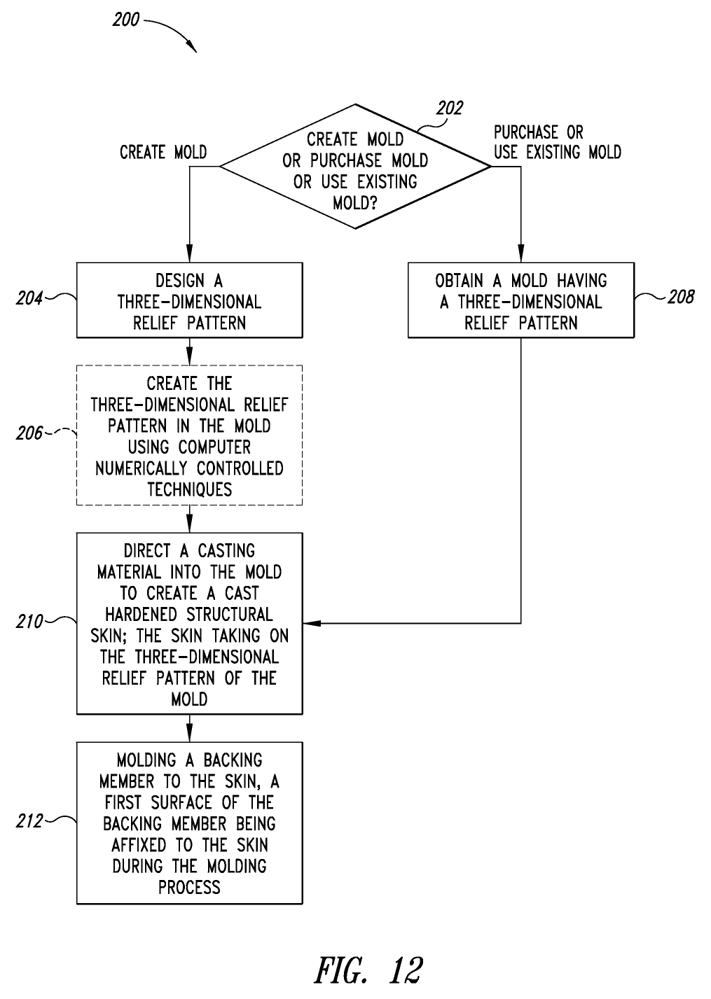

FIG. 12 is a flow diagram illustrating a method 200 of manufacturing a modular, composite panel, such as the composite panel 30 of one of the embodiments discussed above. In 202, either a new mold can be created or a pre-made mold can be purchased or re-used. In 204, when a new mold is created, the three-dimensional relief pattern 44 is designed. In 206, the mold is produced, for example, by using computer numerically controlled (CNC) machining techniques. In addition, a variety of three-dimensional relief patterns 44 that can be created is nearly limitless.

In 208, a pre-made mold can be purchased or re-used. After selecting the mold, in 206, a casting material is poured into the mold to create a cast, hardened structural skin 24 with a three-dimensional relief pattern 44 that conforms with the mold. The casting material is directed into the mold when it is in a slurry or viscous liquid form. Typically, the structural skin 24 sufficiently hardens shortly after it is directed into the mold. The surface of the skin 24 in contact with the mold becomes the visible side of the skin after the panels 30 are assembled and installed.

In 210, the backing member 26 is molded to the skin 24. In one embodiment of the present method, the backing member 26 is formed with the structural skin 24 by pouring a slurry of a mixture of the backing member 26 onto the sufficiently hardened structural skin 24. Thus, one surface of the backing member 33 (FIG. 5) becomes affixed to the skin 24 during the molding process such that the backing member 26 and the skin 24 become joined after the backing member 26 has set-up.

A height and width tolerance of the panel 30 during manufacturing is preferably held to ±⅛ of an inch. A tolerance for the thickness of the panel 30 is preferably held to ± 1/16 of an inch. However, one of ordinary skill in the art will appreciate and understand that these tolerances may be narrowed or opened depending on the capability of the manufacturing facility.

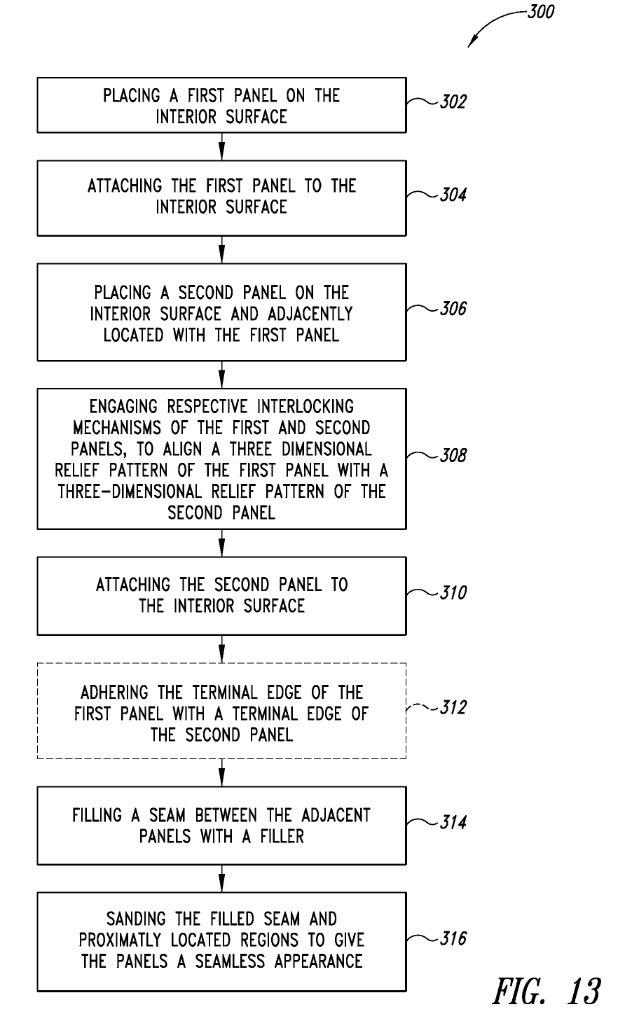

FIG. 13 is a flow diagram illustrating a method 300 of installing modular panels, such as the modular panels 130, 131 according one of the embodiments discussed above, onto an interior surface 18. In 302, the first panel 130 is placed onto the interior surface 18. In 304, the first panel 130 is attached to the interior surface 18 with fasteners, adhesive, or other well-known attachment techniques. In one embodiment, as previously described, the first panel 130 can have pre-cast mounting points. The first panel 130 can be attached to existing drywall using drywall anchors known in the art. If a portion of the first panel 130 is attached to a wall stud, for example, the amount of torque applied to the fastener should be controlled as the fastener is seated into the first panel 130.

Additionally or alternatively, if other mounting points are desired aside from the pre-cast mounting points, additional mounting points can be provided by using a countersink drill-bit. When drilling additional mounting points, care should be taken to not crack or break through the structural skin of the panel. Further, the first panel 130 should be hung plumb and level if installed on a vertical surface, such as the wall 12 of the interior 18.

In 306, the at least second panel 131 can be placed on the interior surface 18 and adjacent to the first panel 130. The second panel 131 can be placed on either side, above, or below the first panel 130. It is not necessary that the terminal edges 129 of the panels 130, 131 be in actual physical contact. In some embodiments it may be beneficial that the edges 129 be in contact and in some embodiments, for example due to environmental circumstances, it may be beneficial to leave a gap between the terminal edges 129 of the panels 130, 131, for example to allow the panels 130, 131 to better flex with the wall 12. In addition, a gap between the panels 130, 131 also permits some play in the panel system 120 due to thermal or humidity effects.

In 308, one manner in which the panels 130, 131 can be aligned includes aligning the three-dimensional relief patterns of each panel 130, 131 by engaging the interlocking mechanisms 146 of the respective first and second panels 130, 131 to one another. Engaging the interlocking mechanisms 146 assures that the overall panel system 120 will have a continual, flowing visual appearance when the installation is complete. A mismatch tolerance of ± 1/32 of an inch between adjacent panels is provided as a guideline, however an experienced installer working with a more lenient three-dimensional pattern may be able to adjust for a larger mismatch without adversely affecting the overall appearance of the panel system 120. In some patterns, for example the pattern of FIG. 2A, the mismatch tolerance should be monitored closely in order to permit the stems of the three-dimensional leaf pattern to be adequately aligned with the adjacently located panels.

Once the panels 130, 131 are sufficiently aligned, the second panel 131 is attached to the interior surface 18 in 310. Attachment of the second panel 131 is accomplished in a manner similar to that described above to attach the first panel 130.

In 312, which is optional, a bonding agent is used in the seam or gap between the two adjacently located panels 130, 131. The bonding agent can be a polyurethane glue or a construction mastic such as LIQUID NAILS®. The terminal edges 129 of the adjacently located panels 130, 131 are joined when a liberal bead of glue is applied to joint or seam and allowed to set. After the glue has set, excess glue can be cleaned off and if any glue extends beyond the surface of the structural skin, then this glue can be trimmed off, if necessary, with a snap-off tool or mat knife. Alternatively, the joint can be sanded to scuff up the surface near the seam and the glue surface, to remove any dry glue residue, to reduce any variation between the outer surfaces of the panels 130, 131 that are adjacently positioned when assembled, or any combination of the above.

In 314, the seams between the adjacent panels 130, 131 are filled with a filler. A preferred filler comprises a vinyl or acrylic additive, is softer than the structural skin, and can be easily sanded. Fillers such as DAP® Vinyl Spackling or DAP® FAST 'N FINAL® Lightweight Spackling, both commonly available, work well for filling the seams between adjacent panels 130, 131. After the seams are filled, the seams and the surrounding area are sanded in 316. The sanding process blends out the seam and provides the panel system with the continual, sculptural effect where the individual panels 130, 131 become a panel system 120. Some final operations that can be performed on the panels 130, 131 are sealing the panels 130, 131 with a polyvinyl acetate based sealer and painting the panels 130, 131. Flat paint is preferable so that the interior room lighting does not highlight minor imperfections, which is more likely if gloss or semi-gloss paint is used.

Although the panels 30 have been discussed in the context of their aesthetic appearance, the embodiments of this disclosure are not limited in scope to a specific use of the panel. For example, the irregular surface, provided by the three-dimensional pattern on the panel, can tend to diffuse reflected sound within a room.

Further, in embodiments where the reinforced skin 24 is combined with the backing member 26, which is made from the lower density material, the weight of the panel can be significantly reduced. Lighter panels are easier to install and may also reduce the stress around the mounting points 28 of the panel after installation, for example during building flexure. For example, the second material can include a lightweight aggregate, for example, a low density mineral aggregate. In addition, or instead, the second material may include lightweight filler.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A composite panel for use, with at least one adjacent composite panel, in covering an interior surface of a structure, the composite panel comprising:
a hardened structural skin fabricated from a first material, a first surface of the structural skin defining an outer surface of the panel having a three-dimensional relief, a magnitude of the relief varying over an area of the outer surface for defining a three-dimensional pattern, a second surface defining an inner surface of the hardened structural skin, a distance between the first and second surfaces defining a thickness of the hardened structural skin;
a backing member fabricated from a second material, the backing member having a first surface and a second surface, opposing the first surface, the first surface being bonded to the second surface of the hardened structural skin, the second surface of the backing member having a substantially flat portion to form an inner surface of the panel for being positioned against the interior surface of the structure; and
a perimeter having a plurality of projections and recesses positioned such that when the projections of the composite panel engages the recesses of the at least one adjacent composite panel, a height of the three-dimensional pattern aligns and the pattern seamlessly continues, from the composite panel into the at least one adjacent composite panel.

2. The composite panel of claim 1 wherein at least one of the first and second material include a gypsum based or fiber reinforced gypsum based material.

3. The composite panel of claim 1 wherein the first material is different from the second material.

4. The composite panel of claim 1 wherein the second material includes a lower density than a density of the first material.

5. The composite panel of claim 1, further comprising:
at least one grommet contiguous with and extending from the structural skin at least partially toward the inner surface of the panel, the grommet being integral with the hardened structural skin; and
an opening extending through the grommet and the hardened structural skin.

6. The composite panel of claim 1 wherein the backing member is fabricated from material including at least one of plaster material, a lightweight aggregate, and embedded with fibers.

7. The composite panel of claim 6 wherein the backing member is fabricated from material including the lightweight aggregate and the lightweight aggregate is a lightweight mineral aggregate.

8. The composite panel of claim 1 wherein the three-dimensional relief extends to at least one of the terminal edges of the panel.

9. The composite panel of claim 1 wherein each of the plurality of projections of the composite panel comprise an at least partially arcuate tab and each of the plurality of recesses of the at least one adjacent panel comprise an at least partially arcuate crevice, the crevice being shaped to complementary receive the arcuate tab, the arcuate tab and the crevice being formed such that when the arcuate tab extends into the crevice and the periphery of the composite panel positions contiguous the periphery of the adjacent composite panel, the three-dimensional pattern seamlessly continues in all three dimensions, from the composite panel into the at least one adjacent composite panel, thereby providing a user an aligning mechanism and substantially preventing user error in aligning the composite panel with the at least one adjacent composite panel.

10. The composite panel of claim 1 wherein at least one of the plurality of projections is removable.

11. A system for aesthetically covering at least a portion of at least one wall comprising:
a plurality of panels each having a first surface and a second surface, opposing the first surface, a distance between the first and second surfaces defining a depth of the panel, the depth varying across at least a portion of the panel for defining a sculptural relief and forming a three-dimensional pattern on the first surface, the second surface being configured to conform to a surface of the at least one wall and be affixed to the at least one wall for displaying the three-dimensional pattern, the sculptural relief of each panel being formed such that when the panels are assembled to form the system, the three-dimensional pattern seamlessly flows into adjacent panels in all three dimensions, providing an appearance of a unitary panel having a seamless integral three-dimensional pattern formed by the individual three-dimensional patterns of each panel; and
a plurality of interlocking mechanisms formed along a perimeter of each panel, the interlocking mechanisms of one panel being configured to engage the interlocking mechanisms of adjacent panels, respectively, the individual three-dimensional patterns aligning along all three dimensions when the interlocking mechanisms are engaged.

12. The system of claim 11 wherein the interlocking mechanism comprises a protrusion and a recess and the protrusion of the interlocking mechanism of each panel is configured to fixedly engage the recess of the adjacent panels.

13. The system of claim 11 wherein the interlocking mechanism comprises a key formed on a perimeter of at least one panel and a slot formed on a perimeter of panels positionable adjacent the at least one panel, the key having a first flange extending in a first direction and a second flange extending in a second direction, different from the first direction, the slot having a first recess adjacent an outermost edge of the periphery and a second recess open to the first recess and spaced from the outermost edge, the first recess being sized to receive the first and second flanges of the key, and the second recess being sized to securely receive the second flange of the key and prevent lateral movement thereof toward the outermost periphery.

14. The system of claim 11 wherein the interlocking mechanism of each panel comprises a tab and a slot, the slot of each panel being shaped to complementarily receive the tab of a predetermined adjacent panel, the tab and the slot being formed such that when the tab extends into the slot and the periphery of adjacent panels meet, the three-dimensional pattern seamlessly continues in all three dimensions, from each panel into the adjacent panels, thereby providing a user an aligning mechanism for achieving the seamless integral three-dimensional pattern.

15. The system of claim 11 wherein the gypsum based material is fiber reinforced gypsum.

16. The system of claim 11, further comprising:
at least one grommet contiguous with and extending from the structural skin at least partially toward the rear surface of the panel, the grommet being integral with the hardened structural skin; and
an opening extending through the grommet and the hardened structural skin.

17. The composite panel of claim 11 wherein the backing member is fabricated from material including at least one of plaster material, a lightweight aggregate, and embedded with fibers.

18. The composite panel of claim 17 wherein the backing member is fabricated from material including the lightweight aggregate and the lightweight aggregate is a lightweight mineral aggregate.

19. The system of claim 11 wherein the three-dimensional relief extends to at least one of the terminal edges of the panel.

20. The composite panel of claim 11 wherein at least one of the interlocking mechanisms is removable.
